(19) United States
(12) Patent Application Publication
(10) Pub. No.: US 2025/0104730 A1
(43) Pub. Date: Mar. 27, 2025

(54) VOICE DETECTION APPARATUS, VOICE DETECTION METHOD, AND RECORDING MEDIUM

(71) Applicant: NEC Corporation, Minato-ku, Tokyo (JP)

(72) Inventors: Koji OKABE, Tokyo (JP); Hitoshi YAMAMOTO, Tokyo (JP)

(73) Assignee: NEC Corporation, Minato-ku, Tokyo (JP)

(21) Appl. No.: 18/728,141

(22) PCT Filed: Mar. 22, 2022
(86) PCT No.: PCT/JP2022/013089

§ 371 Date: Jul. 11, 2024

(51) Int. Cl. G10L 25/78; G10L 15/26

(52) U.S. Cl. CPC G10L 25/78; G10L 15/26; G10L 2025/783

(57) ABSTRACT

A voice detection apparatus includes: a beginning determination unit that determines a beginning of a voice segment including a voice that appears in a voice signal; an end determination unit that determines an end of the voice segment by determining whether or not a length of a non-voice segment that appears after the beginning is determined, is greater than or equal to a threshold; and a setting unit that sets the threshold on the basis of a property of a provisional voice segment starting from the beginning.

### TECHNICAL FIELD

This disclosure relates to technical fields of a voice detection apparatus, a voice detection method, and a recording medium that are configured to detect a voice segment that appears in a voice signal.

### BACKGROUND ART

Patent Literature 1 describes an example of a voice detection apparatus that is configured to detect a voice segment that appears in a voice signal. In addition, as prior art documents related to this disclosure, Patent Literature 2 to Patent Literature 4 and Non-Patent Literature 1 are cited.

### CITATION LIST

### Patent Literature

Patent Literature 1: International Publication No. WO2021/014612 pamphlet
Patent Literature 2: International Publication No. WO2016/143125 pamphlet
Patent Literature 3: JP2017-097330A
Patent Literature 4: International Publication No. WO2015/059947 pamphlet

### Non-Patent Literature

Non-Patent Literature 1: Takenori Yoshimura et. al, “END-TO-END AUTOMATIC SPEECH RECOGNITION INTEGRATED WITH CTC-BASED VOICE ACTIVITY DETECTION”, arXiv 2002.00551, Feb. 14, 2020

### SUMMARY

### Technical Problem

It is an example object of this disclosure to provide a voice detection apparatus, a voice detection method, and a recording medium that are intended to improve the techniques/technologies described in Citation List.

### Solution to Problem

A voice detection apparatus according to an example aspect of this disclosure includes: a beginning determination unit that determines a beginning of a voice segment including a voice that appears in a voice signal: an end determination unit that determines an end of the voice segment by determining whether or not a length of a non-voice segment that appears after the beginning is determined, is greater than or equal to a threshold; and a setting unit that sets the threshold on the basis of a property of a provisional voice segment starting from the beginning.

A voice detection method according to an example aspect of this disclosure includes: determining a beginning of a voice segment including a voice that appears in a voice signal; determining an end of the voice segment by determining whether or not a length of a non-voice segment that appears after the beginning is determined, is greater than or equal to a threshold; and setting the threshold on the basis of a property of a provisional voice segment starting from the beginning.

A recording medium according to an example aspect of this disclosure is a recording medium on which a computer program that allows a computer to execute a voice detection method is recorded, the voice detection method including: determining a beginning of a voice segment including a voice that appears in a voice signal: determining an end of the voice segment by determining whether or not a length of a non-voice segment that appears after the beginning is determined, is greater than or equal to a threshold; and setting the threshold on the basis of a property of a provisional voice segment starting from the beginning.

### BRIEF DESCRIPTION OF DRAWINGS

FIG. 1 is a block diagram illustrating a configuration of a voice detection apparatus in a first example embodiment.

FIG. 2 illustrates a relation between a voice signal, a voice segment, and a non-voice segment.

FIG. 3 is a block diagram illustrating a configuration of a voice detection apparatus in a second example embodiment.

FIG. 4 is a block diagram illustrating a configuration of a symbol generation unit.

FIG. 5A illustrates a method of determining a beginning of the voice segment with symbol data, and FIG. 5B illustrates a method of determining an end of the voice segment with symbol data.

FIG. 6 is a flowchart illustrating a flow of a voice detection operation performed by the voice detection apparatus in the second example embodiment.

FIG. 7 illustrates symbol data in which the beginning of the voice segment is determined.

FIG. 8 is a graph illustrating an example of a relation between a length of a provisional voice segment and a threshold.

FIG. 9A illustrates a voice segment detected by a voice detection apparatus in a comparative example, and FIG. 9B illustrates a voice segment detected by the voice detection apparatus in the second example embodiment.

FIG. 10A illustrates a voice segment detected by a voice detection apparatus in a comparative example, and FIG. 10B illustrates a voice segment detected by the voice detection apparatus in the second example embodiment.

FIG. 11 Each of FIG. 11A to FIG. 11C is a graph illustrating an example of the relation between the length of the provisional voice segment and the threshold.

FIG. 12 is a block diagram illustrating a configuration of a voice detection apparatus in a third example embodiment.

FIG. 13 is a block diagram illustrating a configuration of a voice detection apparatus in a fourth example embodiment.

FIG. 14 is a block diagram illustrating a configuration of a voice detection apparatus in a fifth example embodiment.

### DESCRIPTION OF EXAMPLE EMBODIMENTS

Hereinafter, with reference to the drawings, a voice detection apparatus, a voice detection method, and a recording medium according to example embodiments will be described.

### (1) First Example Embodiment

First, a voice detection apparatus, a voice detection method, and a recording medium according to a first example embodiment will be described. With reference to FIG. 1, the following describes the voice detection apparatus, the voice detection method, and the recording medium according to the first example embodiment, by using a voice detection apparatus 1000 to which the voice detection apparatus, the voice detection method, and the recording medium according to the first example embodiment are applied. FIG. 1 is a block diagram illustrating the configuration of the voice detection apparatus 1000 in the first example embodiment.

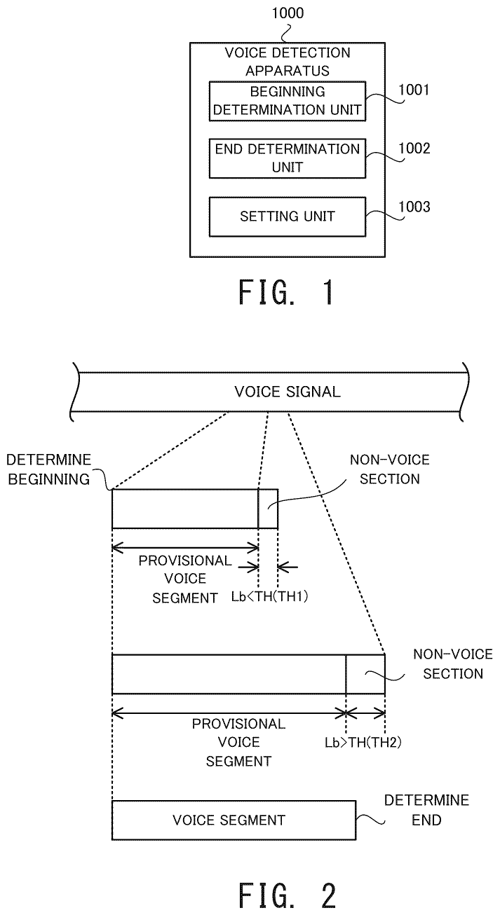

As illustrated in FIG. 1, the voice detection apparatus 1000 includes a beginning determination unit 1001, an end determination unit 1002, and a setting unit 1003. As illustrated in FIG. 2, the beginning determination unit 1001 determines a beginning of a voice segment that appears in a voice signal. The end determination unit 1002 determines an end of the voice segment by determining whether or not a length Lb of a non-voice segment that appears after the beginning is determined is greater than or equal to a threshold TH, as illustrated in FIG. 2. For example, the end determination unit 1002 may determine a time that is determined on the basis of a time when the length Lb of the non-voice segment is greater than or equal to the threshold TH, to be a time corresponding to the end of the voice segment. The setting unit 1003 sets the threshold TH on the basis of a property of a provisional voice segment starting from the beginning (i.e., a provisional voice segment in which the end is not yet determined). For example, as illustrated in FIG. 2, the setting unit 1003 may set the threshold TH such that the threshold TH is changed from a first candidate value TH1 to a second candidate value TH2 when the property (in the example illustrated in FIG. 2, the length) of the provisional voice segment changes.

As described above, the voice detection apparatus 1000 in the first example embodiment is configured to set (i.e., change) the threshold TH on the basis of a length Lt of the provisional voice segment. Therefore, the voice detection apparatus 1000 is capable of detecting the voice segment with an appropriate length for a post-processing operation (e.g., a voice recognition operation, a voice authentication operation, or an emotion recognition operation) performed after the voice segment is detected.

### (2) Second Example Embodiment

Next, a voice detection apparatus, a voice detection method, and a recording medium according to a second example embodiment will be described. The following describes the voice detection apparatus, the voice detection method, and the recording medium according to the second example embodiment, by using a voice detection apparatus 1 to which the voice detection apparatus, the voice detection method, and the recording medium according to the second example embodiment are applied.

The voice detection apparatus 1 is an apparatus that performs voice activity detection (VAD). The voice activity detection is an operation of detecting a voice segment, from a voice signal indicating a voice uttered by a speaker. In other words, the voice activity detection is an operation of distinguishing the voice segment that appears in the voice signal, from the non-voice segment that appears in the voice signal. The voice segment is a segment including the voice uttered by the speaker. That is, the voice segment is a segment in which the speaker is speaking. On the other hand, the non-voice segment is different from the voice segment. Typically, the non-voice segment is a segment in which the speaker is not speaking.

Hereinafter, the voice detection apparatus 1 that performs such voice activity detection will be described.

### (2-1) Configuration of Voice Detection Apparatus 1

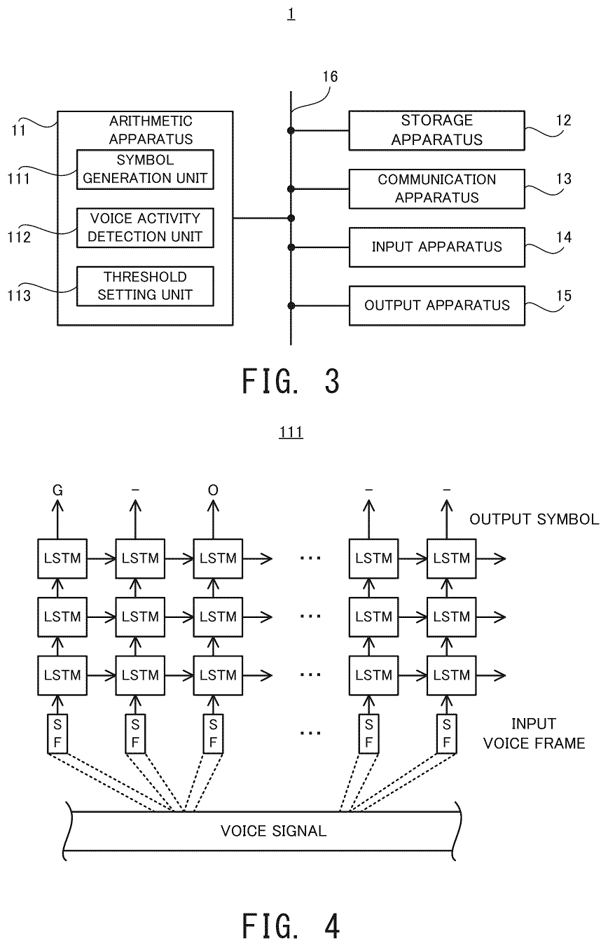

First, with reference to FIG. 3, a configuration of the voice detection apparatus 1 in the second example embodiment will be described. FIG. 3 is a block diagram illustrating a configuration of the voice detection apparatus 1 in the second example embodiment.

As illustrated in FIG. 3, the voice detection apparatus 1 includes an arithmetic apparatus 11, a storage apparatus 12, and a communication apparatus 13. Furthermore, the voice detection apparatus 1 may include an input apparatus 14 and an output apparatus 15. The voice detection apparatus 1, however, may not include at least one of the input apparatus 14 and the output apparatus 15. The arithmetic apparatus 11, the storage apparatus 12, the communication apparatus 13, the input apparatus 14, and the output apparatus 15 may be connected through a data 25 bus 16.

The arithmetic apparatus 11 includes, for example, at least one of a CPU (Central Processing Unit), a GPU (Graphics Processing Unit), and a FPGA (Field Programmable Gate Array). The arithmetic apparatus 11 reads a computer program. For example, the arithmetic apparatus 11 may read a computer program stored in the storage apparatus 12. For example, the arithmetic apparatus 11 may read a computer program stored by a computer-readable and non-transitory recording medium, by using a not-illustrated recording medium reading apparatus provided in the voice detection apparatus 1. The arithmetic apparatus 11 may acquire (i.e., download or read) a computer program from a not-illustrated apparatus disposed outside the voice detection apparatus 1, through the communication apparatus 13 (or another communication apparatus). The arithmetic apparatus 11 executes the read computer program. Consequently, a logical functional block for performing an operation to be performed by the voice detection apparatus 1 (e.g., the voice activity detection described above) is realized or implemented in the arithmetic apparatus 11. That is, the arithmetic apparatus 11 is allowed to function as a controller for realizing or implementing the logical functional block for performing an operation (in other words, processing) to be performed by the voice detection apparatus 1.

FIG. 3 illustrates an example of the logical functional block realized or implemented in the arithmetic apparatus 11 to perform the voice activity detection. As illustrated in FIG. 3, a symbol generation unit 111 that is a specific example of the “generation unit” described later in Supplementary Note, a voice activity detection unit 112 that is a specific example of each of the “beginning determination unit” and the “end determination unit” described later in Supplementary Note, and a threshold setting unit 113 that is a specific example of the “setting unit” described later in Supplementary Note are realized or implemented in the arithmetic apparatus 11.

The symbol generation unit 111 generates symbol data from the voice signal. Specifically; the symbol generation unit 111 outputs a symbol for each voice frame SF (e.g., voice frame SF of several tens of milliseconds) obtained by subdividing/segmenting the voice signal. The symbol may include a character symbol representing the voice uttered by the speaker in the voice frame SF, as a character. One character symbol may represent one character (e.g., one alphabetical letter, one Hiragana character, one Korean alphabet or Hangul, or one Kanji character). As an example, one character symbol may represent a single alphabet of “a”. One character symbol may represent a plurality of characters (e.g., a plurality of alphabetical letters, a plurality of Hiragana characters, a plurality of Korean alphabets, or a plurality of Kanji characters). As an example, one character symbol may represent a plurality of alphabetical letters “pat.” The symbol may include a blank symbol indicating that the speaker is not speaking in the voice frame SF. As a result, the symbol generation unit 111 generates symbol data in which a plurality of outputted symbols are arranged along time series. The character symbol may be a symbol representing a character itself (e.g., Hiragana or alphabet), or may be a symbol representing a phoneme that is the smallest unit of the character.

In the second example embodiment, the symbol generation unit 111 generates the symbol data from the voice signal by using a CTC (Connectionist Temporal Classification) model. A method of generating the symbol data from the voice signal by using the CTC model is described in Non-Patent Literature 1. Therefore, a detailed description of the method of generating the symbol data from the voice signal by using the CTC model will be omitted, but an outline thereof will be briefly described below with reference to FIG. 4. The symbol generation unit 111 that generates the symbol data from the voice signal by using the CTC model, may be realized or implemented by a recursive neural network, as illustrated in FIG. 2. Specifically, the symbol generation unit 111 divides the voice signal into a plurality of voice frames SF, and inputs the plurality of voice frames SF to a plurality of LTSMs (Long Short Term Memory), respectively. A neural network including a plurality of LTSMs outputs such a posterior probability that each of a plurality of types of characters is a character corresponding to the voice uttered by the speaker in each voice frame SF. Thereafter, the symbol generation unit 111 generates, as the symbol data, sequence data about a sequence of a plurality of symbols that constitute a character string having the highest posterior probability: FIG. 4 illustrates an example of the symbol data generated by the symbol generation unit 111 in a case where the posterior probability of a character string of “G-O--” is the highest.

In FIG. 4, a mark “-” means the blank symbol. The blank symbol is outputted when it is unlikely that the voice is uttered in a certain voice frame SF. That is, the blank symbol is outputted when there is no character corresponding to a certain voice frame.

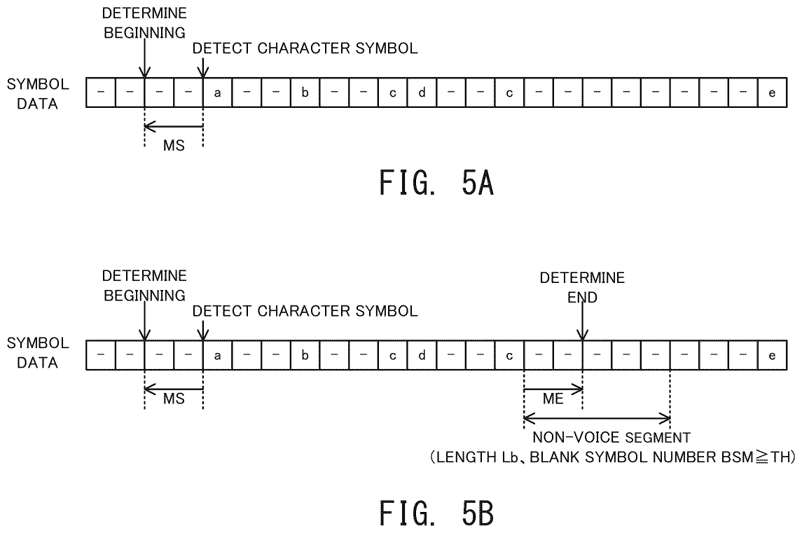

Referring again to FIG. 3, the voice activity detection unit 112 detects the voice segment by using the symbol data generated by the symbol generation unit 111. An outline of the operation of detecting the voice segment by the voice activity detection unit 112 will be described with reference to FIG. 5A and FIG. 5B.

First, as illustrated in FIG. 5A, the voice activity detection unit 112 determines the beginning of the voice segment. Specifically, the voice activity detection unit 112 searches the symbol data along the time series in a situation where the beginning of the voice segment is not yet determined (i.e., is undetected), thereby detecting the character symbol. Thereafter, the voice activity detection unit 112 determines a voice frame SF that is a predetermined frame number MS before the voice frame SF in which the character symbol is detected, to be the beginning of the voice segment. In the example illustrated in FIG. 5A, the predetermined frame number MS is 2. The predetermined frame number MS may be 0, 1, 3 or more.

Thereafter, the voice activity detection unit 112 determines the end of the voice segment. Specifically; as illustrated in FIG. 5B, the voice activity detection unit 112 searches the symbol data along the time series in a situation where the beginning of the voice segment is determined, thereby determining whether or not the length Lb of the non-voice segment that appears after the beginning of the voice segment is determined is greater than or equal to the predetermined threshold TH. The non-voice segment is a segment in which the blank symbol is outputted. In this case, as the length Lb of the non-voice segment, the number of blank symbols outputted continuously in the time series (i.e., the number of voice frames SF in which the blank symbol is outputted) may be used. The following describes an example in which the number of blank symbols outputted continuously in the time series (hereinafter referred to as a “blank symbol number BSN”) is used as the length Lb of the non-voice segment. When it is determined that the blank symbol number BSN is greater than or equal to the predetermined threshold TH (i.e., the length Lb of the non-voice segment is greater than or equal to the predetermined threshold TH), a voice frame that is a predetermined frame number ME after the voice frame in which the character symbol is detected at last, is determined to be the end of the voice segment. In the example illustrated in FIG. 5B, the predetermined frame number ME is 2. The predetermined frame number ME may be 0, 1, 3 or more.

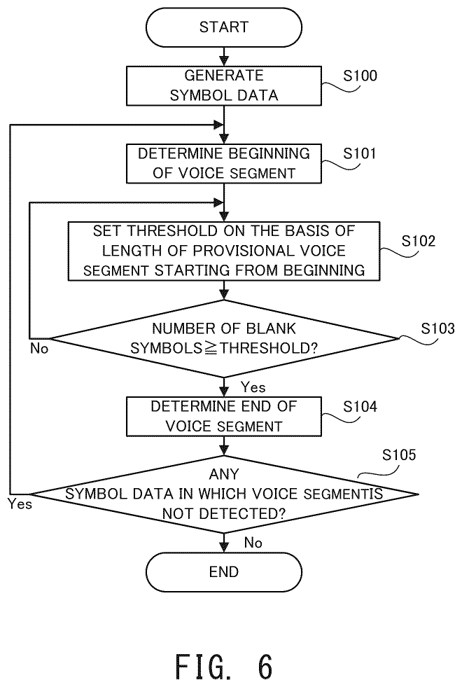

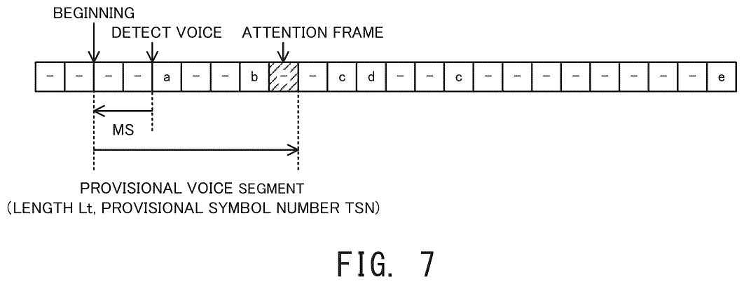

Referring back to FIG. 3, the threshold setting unit 113 sets the threshold TH to be used by the voice activity detection unit 112 to determine the end of the voice segment. A method of setting the threshold TH by the threshold setting unit 113 will be described in detail later with reference to FIG. 6 and the like.

The storage apparatus 12 is configured to store desired data. For example, the storage apparatus 12 may temporarily store a computer program to be executed by the arithmetic apparatus 11. The storage apparatus 12 may temporarily store data that are temporarily used by the arithmetic apparatus 11 when the arithmetic apparatus 11 executes the computer program. The storage apparatus 12 may store data that are stored by the voice detection apparatus 1 for a long time. The storage apparatus 12 may include at least one of a RAM (Random Access Memory), a ROM (Read Only Memory), a hard disk apparatus, a magneto-optical disk apparatus, a SSD (Solid State Drive), and a disk array apparatus. That is, the storage apparatus 12 may include a non-transitory recording medium.

The communication apparatus 13 is configured to communicate with an external apparatus of the voice detection apparatus 1.

The input apparatus 14 is an apparatus that receives an input of information to the voice detection apparatus 1 from an outside of the voice detection apparatus 1. For example, the input apparatus 14 may include an operating apparatus (e.g., at least one of a keyboard, a mouse, and a touch panel) that is operable by an operator of the voice detection apparatus 1. For example, the input apparatus 14 may include a reading apparatus that is configured to read information recorded as data on a recording medium that is externally attachable to the voice detection apparatus 1.

The output apparatus 15 is an apparatus that outputs information to the outside of the voice detection apparatus 1. For example, the output apparatus 15 may output information as an image. That is, the output apparatus 15 may include a display apparatus (a so-called display) that is configured to display an image indicating the information that is desirably outputted. For example, the output apparatus 15 may output information as audio/sound. That is, the output apparatus 15 may include an audio apparatus (a so-called speaker device) that is configured to output the audio/sound. For example, the output apparatus 15 may output information onto a paper surface. That is, the output apparatus 15 may include a print apparatus (a so-called printer) that is configured to print desired information on the paper surface.

### (2-2) Voice Detection Operation Performed by Voice Detection Apparatus 1

Next, with reference to FIG. 6, a voice detection operation performed by the voice detection apparatus 1 will be described. FIG. 6 is a flowchart illustrating a flow of the voice detection operation performed by the voice detection apparatus 1 in the second example embodiment.

As illustrated in FIG. 6, the symbol generation unit 111 generates the symbol data from the voice signal (step S100). For example, the symbol generation unit 111 may acquire a voice signal generated by a voice sensor such as a microphone, and may generate the symbol data from the acquired voice signal. In this case, the symbol generation unit 111 may continue to acquire the voice signal and generate the symbol data as long as the voice signal continues to be generated. Alternatively, for example, the symbol generation unit 111 may read a voice signal recorded on a recording medium and generate the symbol data from the read voice data.

Thereafter, the voice activity detection unit 112 determines the beginning of the voice segment on the basis of the symbol data generated in the step S100 (step S101). Thereafter, the voice activity detection unit 112 determines the end of the voice segment on the basis of the symbol data generated in the step S100 (the step S103 to step S104). That is, the voice activity detection unit 112 determines whether or not the blank symbol number BSN is greater than or equal to the threshold TH (step S103). The voice activity detection unit 112 determines the end of the voice segment on the basis of a determination result in the step S103 (step S104).

Especially in the second example embodiment, from when the beginning of the voice segment is determined to when the end of the voice segment is determined, the threshold setting unit 113 sets the threshold TH to be used in the step S103 (step S102). Specifically, the threshold setting unit 113 sets (i.e., changes) the threshold TH on the basis of the property of the provisional voice segment starting from the beginning determined in the S101.

The provisional voice segment means a provisional voice segment in which the end is not yet determined. Specifically, as illustrated in FIG. 7 indicating the symbol data in which the beginning of the voice segment is determined, in the second example embodiment, until the end of the voice segment is determined, the voice segment starting from the beginning determined in the step S101 is referred to as the provisional voice segment in which the end of the voice segment is not definitely determined. As a provisional end of the provisional voice segment, a voice frame SF that is currently attracting attention (hereinafter referred to as an “attention frame”) in order to perform the voice activity detection may be used. The attention frame may mean the voice frame SF corresponding to a last symbol that is already searched at a present time, when the symbol data are searched along the time series in order to perform the voice activity detection.

In the second example embodiment, described is an example in which the length Lt of the provisional voice segment is used as the property of the provisional voice segment. The following describes an example in which the number of voice frame SF included in a provisional voice segment Lt (i.e., the number of symbols included in the provisional voice segment Lt) is used as the length Lt of the provisional voice segment. In this instance, the threshold setting unit 113 sets the threshold TH on the basis of the length Lt of the provisional voice segment. Specifically, the threshold setting unit 113 changes the threshold TH on the basis of the length Lt of the provisional voice segment. For example, the threshold setting unit 113 may set the threshold TH such that the threshold TH set when the length Lt of the provisional voice segment is a first length, is different from the threshold TH set when the length Lt of the provisional voice segment is a second length that is different from the first length.

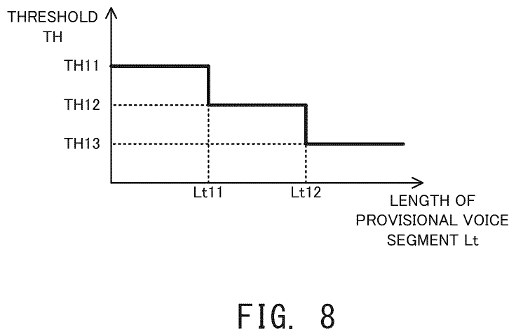

Especially in the second example embodiment, the threshold setting unit 113 may set the threshold TH such that the threshold TH set when the length Lt of the provisional voice segment is the first length, is greater than the threshold TH set when the length Lt of the provisional voice segment is the second length that is longer than the first length. For example, as illustrated in FIG. 8, the threshold setting unit 113 may set the threshold TH to a first candidate value TH11 when the length Lt of the provisional voice segment is shorter than a length Lt11. Furthermore, the threshold setting unit 113 may set the threshold TH to a second candidate value TH12 that is smaller than the first candidate value TH11 when the length Lt of the provisional voice segment is longer than the length Lt11 and is shorter than a length Lt12 (where the length Lt12 is longer than the length Lt11). Furthermore, the threshold setting unit 113 may set the threshold TH to a third candidate value TH13 that is smaller than the second candidate value TH12, when the length Lt of the provisional voice segment is longer than the length Lt12. That is, in the example illustrated in FIG. 8, the threshold setting unit 113 sets the threshold TH to one candidate value that is selected from three different candidate values on the basis of the length Lt of the provisional voice segment.

Referring back to FIG. 6, the voice detection apparatus 1 repeats the same operation until the operation of detecting the voice segment is completed in all the segments of the symbol data generated in the step S100 (step S105).

### (2-3) Technical Effect of Voice Detection Apparatus 1

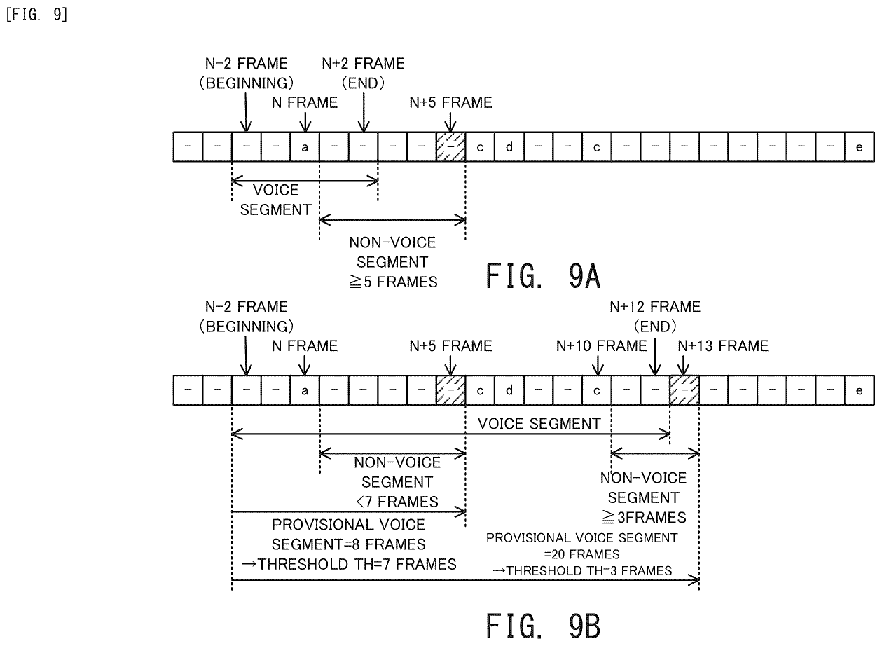

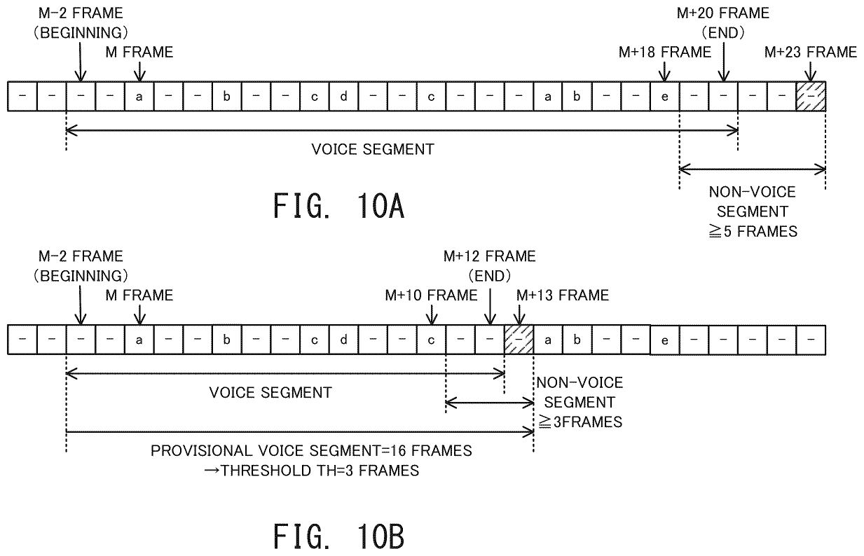

As described above, the voice detection apparatus 1 in the second example embodiment is configured to set (i.e., change) the threshold TH on the basis of the length Lt of the provisional voice segment. Therefore, the voice detection apparatus 1 is capable of detecting the voice segment with an appropriate length for the post-processing operation (e.g., the voice recognition operation, the voice authentication operation, or the emotion recognition operation) performed after the voice segment is detected. Hereinafter, a specific reason why the voice segment with an appropriate length for the post-processing operation can be detected will be described with reference to FIG. 9A to FIG. 9B and FIG. 10A to FIG. 10B.

First, a voice detection apparatus in a comparative example in which the threshold TH is fixed independently of the length Lt of the provisional voice segment, may detect an unnecessarily short voice segment. For example, in a case where the speaker takes a short pose after speaking for a short time, the voice detection apparatus in the comparative example is more likely to detect a short voice segment including the voice uttered in the short time. For example. FIG. 9A illustrates a voice segment detected by the voice detection apparatus in the comparative example in which the threshold TH is fixed to 5 (i.e., 5 frames). In the example illustrated in FIG. 9A, the voice detection apparatus in the comparative example detects a character symbol “a” in timing when an Nth voice frame SF becomes the attention frame, and therefore determines an (N−2)th voice frame SF that is the predetermined frame number MS (in this case. 2 frames) before the Nth voice frame SF, to be the beginning of the voice segment. Then, the voice detection apparatus in the comparative example determines that the length Lb of the non-voice segment (i.e., the blank symbol number BSN) is greater than or equal to the threshold TH, in timing when an (N+5)th voice frame SF becomes the attention frame. Therefore, the voice detection apparatus in the comparative example determines an (N+2)th voice frame SF that is the predetermined frame number ME (in this case. 2 frames) after the Nth voice frame SF in which the character symbol is detected lastly, to be the end of the voice segment. Consequently: the voice detection apparatus in the comparative example detects a relatively short voice segment with a length of five frames. In this case, as illustrated in FIG. 9A, it cannot necessarily be said that the number of character symbols included in the detected voice segment is large. This is because as the voice segment becomes shorter, the number of character symbols included in the voice segment becomes less. That is, the voice detection apparatus in the comparative example may detect a voice segment that is hardly said to include sufficient information. Consequently: accuracy of the post-processing operation performed after the voice segment is detected, may be reduced. For example, context of a sentence representing the voice uttered by the speaker may not be properly understood by the voice recognition operation.

In the second example embodiment, however, the voice detection apparatus 1 determines the threshold TH on the basis of the length Lt of the provisional voice segment. Therefore, as compared with the voice detection apparatus in the comparative example, the voice detection apparatus 1 is less likely to detect an unnecessarily short voice segment. For example. FIG. 9B illustrates a voice segment detected by the voice detection apparatus 1 that sets a threshold TH of 7 (7 frames) when the length Lt of the provisional voice segment is less than or equal to 10 frames, sets a threshold TH of 5 (5 frames) when the length Lt of the provisional voice segment is greater than or equal to 11 frames and is less than or equal to 15 frames, and sets a threshold TH of 3 (3 frames) when the length Lt of the provisional voice segment is greater than or equal to 16 frames. In the example illustrated in FIG. 9B, as in the voice detection apparatus in the comparative example illustrated in FIG. 9A, the voice detection apparatus 1 determines the (N−2)th voice frame SF to be the beginning of the voice segment. At this stage, the threshold TH of 7 is set because the length Lt of the provisional voice segment is 3 frames. Furthermore, even in a case where an (N+5)th voice frame SF becomes the attention frame, the threshold TH of 7 is set because the length Lt of the provisional voice segment is 8 frames. As a result, unlike the voice detection apparatus in the comparative example, the voice detection apparatus 1 does not determine that the length Lb of the non-voice segment is greater than or equal to the threshold TH in timing when the (N+5)th voice frame SF becomes the attention frame. Thereafter, when an (N+13)th voice frame SF becomes the attention frame, the length Lt of the provisional voice segment is greater than or equal to 16 frames, and therefore, the threshold TH of 3 is set. Consequently: the voice detection apparatus 1 determines that the length Lb of the non-voice segment is greater than or equal to the threshold TH in timing when the (N+13)th voice frame SF becomes the attention frame. Therefore, the voice detection apparatus 1 determines an (N+12)th voice frame SF that is the predetermined frame number ME (in this case. 2 frames) after an (N+10)th voice frame SF in which the character symbol is detected lastly, to be the end of the voice segment. Consequently, the voice detection apparatus 1 detects a longer voice segment than the voice segment detected by the voice detection apparatus in the comparative example. That is, the voice detection apparatus 1 is capable of solving such a technical problem that an unnecessarily short voice segment is detected. Therefore, the voice detection apparatus 1 is more likely to detect a voice segment including sufficient information, as compared with the voice detection apparatus in the comparative example. Consequently, the accuracy of the post-processing operation performed after the voice segment is detected by the voice detection apparatus 1, is higher than that of the post-processing operation performed after the voice segment is detected by the voice detection apparatus in the comparative example.

On the other hand, the voice detection apparatus in the comparative example in which the threshold TH is fixed independently of the length Lt of the provisional voice segment, may detect an unnecessarily long voice segment, in addition to or in place of an unnecessarily short voice segment. For example, in a case where the speaker is continuously speaking fast, the voice detection apparatus in the comparative example is likely to detect an unnecessarily long voice segment. For example. FIG. 10A illustrates a voice segment detected by the voice detection apparatus in the comparative example in which the threshold TH is fixed to 5 (5 frames). In the example illustrated in FIG. 10A, the voice detection apparatus in the comparative example detects the character symbol “a” in timing when an Mth voice frame SF becomes the attention frame, and therefore determines an (M−2) voice frame SF that is the predetermined frame number MS (in this case. 2 frames) before the Mth voice frame SF, to be the beginning of the voice segment. Then, the voice detection apparatus in the comparative example determines that the length Lb of the non-voice segment (i.e., the blank symbol number BSN) is greater than or equal to the threshold TH in timing when an (M+23)th voice frame SF becomes the attention frame. Therefore, the voice detection apparatus in the comparative example determines an (M+20)th voice frame SF that is the predetermined frame number ME (in this case. 2 frames) after an (M+18)th voice frame SF in which the character symbol is detected lastly: to be the end of the voice segment. Consequently, the voice detection apparatus in the comparative example detects a relatively long voice segment with a length of 24 frames. In this situation, a calculation amount required for the post-processing operation performed after the voice segment is detected, may be excessive. That is because as the voice segment becomes longer, a larger calculation amount is required for the post-processing operation performed after the voice segment is detected. Therefore, a delay time may be increased from when the voice signal is inputted to the voice detection apparatus in the comparative example to when a result of the post-processing operation is outputted.

In the second example embodiment, however, the voice detection apparatus 1 determines the threshold TH on the basis of the length Lt of the provisional voice segment. Therefore, the voice detection apparatus 1 is less likely to detect an unnecessarily long voice segment, as compared with the voice detection apparatus in the comparative example. For example. FIG. 10B illustrates a voice segment detected by the voice detection apparatus 1 that sets a threshold TH of 7 (7 frames) when the length Lt of the provisional voice segment is less than or equal to 10 frames, sets a threshold TH of 5 (5 frames) when the length Lt of the provisional voice segment is greater than or equal to 11 frames and is less than or equal to 15 frames, and sets a threshold TH of 3 (3 frames) when the length Lt of the provisional voice segment is greater than or equal to 16 frames. In the example illustrated in FIG. 10B, as in the voice detection apparatus in the comparative example illustrated in FIG. 10A, the voice detection apparatus 1 determines the (M−2)th voice frame SF to be the beginning of the voice segment. Thereafter, when an (M+13)th voice frame SF becomes the attention frame, the length Lt of the provisional voice segment is greater than or equal to 16 frames, and therefore, the threshold TH of 3 is set. Consequently, the voice detection apparatus 1 determines that the length Lb of the non-voice segment is greater than or equal to the threshold TH in timing when the (M+13)th voice frame SF becomes the attention frame. Therefore, the voice detection apparatus 1 determines an (M+12)th voice frame SF that is the predetermined frame number ME (in this case, 2 frames) after an (M+10)th voice frame SF in which the character symbol is last detected lastly, to be the end of the voice segment. Consequently; the voice detection apparatus 1 detects a shorter voice segment than the voice segment detected by the voice detection apparatus in the comparative example. That is, the voice detection apparatus 1 is capable of solving such a technical problem that an unnecessarily long voice segment is detected. Therefore, the voice detection apparatus 1 is less likely to detect a voice segment in which the calculation amount required for the post-processing operation is excessive, as compared with the voice detection apparatus in the comparative example. Consequently; the calculation amount required for the post-processing operation performed after the voice segment is detected by the voice detection apparatus 1, is smaller than that required for the post-processing operation after the voice segment is detected by the voice detection apparatus in the comparative example.

As described above, the voice detection apparatus 1 is less likely to detect an unnecessarily short or long voice segment for the post-processing operation performed after the voice segment is detected, as compared with the voice detection apparatus in the comparative example. That is, the voice detection apparatus 1 is capable of detecting the voice segment with an appropriate length for the post-processing operation performed after the voice segment is detected.

In view of the above-described technical effect, it is preferable that the voice detection apparatus 1 sets the threshold TH on the basis of the length Lt of the provisional voice segment so as to achieve both the effect of detecting the voice segment with a length long enough to understand the context of a sentence indicated by the voice uttered by the speaker and the effect of providing an appropriate calculation amount required for the post-processing operation.

In addition, the voice detection apparatus 1 detects the voice segment by using the symbol data generated by using the CTC model. Therefore, the voice detection apparatus 1 is capable of properly detecting the voice segment.

### (2-4) Modified Examples

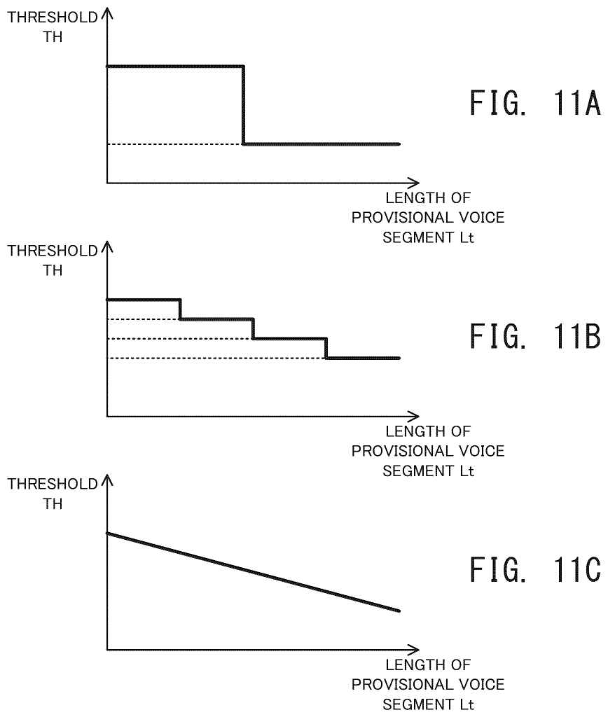

In the example illustrated in FIG. 8, the threshold setting unit 113 sets the threshold TH to one candidate value that is selected from three different candidate on the basis of the length Lt of the provisional voice segment. The method of setting the threshold TH illustrated in FIG. 8, however, is an example, and the method of setting the threshold TH is not limited to the setting method illustrated in FIG. 8. For example, as illustrated in FIG. 11A, the threshold setting unit 113 may set the threshold TH to one candidate value that is selected from two different candidate values on the basis of the length Lt of the provisional voice segment. For example, as illustrated in FIG. 11B, the threshold setting unit 113 may set the threshold TH to one candidate value that is selected from four or more different candidate values on the basis of the length Lt of the provisional voice segment. For example, as illustrated in FIG. 11C, the threshold setting unit 113 may continuously change the threshold TH on the basis of the length Lt of the provisional voice segment, in addition to or in place of changing the threshold TH stepwise on the basis of the length Lt of the provisional voice segment, as illustrated in FIG. 8, FIG. 11A, and FIG. 11B.

In the above description, the voice activity detection unit 112 determines the end of the voice segment on the basis of the symbol data including a plurality of symbols that constitute the character string having the highest posterior probability. The voice activity detection unit 112, however, may determine the end of the voice segment on the basis of the symbol data including a plurality of symbols that constitute a character string having a posterior probability that is not the highest, but relatively high. For example, the voice activity detection unit 112 may determine the end of the voice segment on the basis of the symbol data including a plurality of symbols that constitute a character string having an Nth highest posterior probability (where N is an integer of 1 or more). That is, the voice activity detection unit 112 may determine whether or not the length Lb of the non-voice segment is greater than or equal to the predetermined threshold TH by using the symbol data including the plurality of symbols that constitute the character string having the Nth highest posterior probability. Even in this case, the voice activity detection unit 112 is capable of properly setting the end of the voice segment.

### (3) Third Example Embodiment

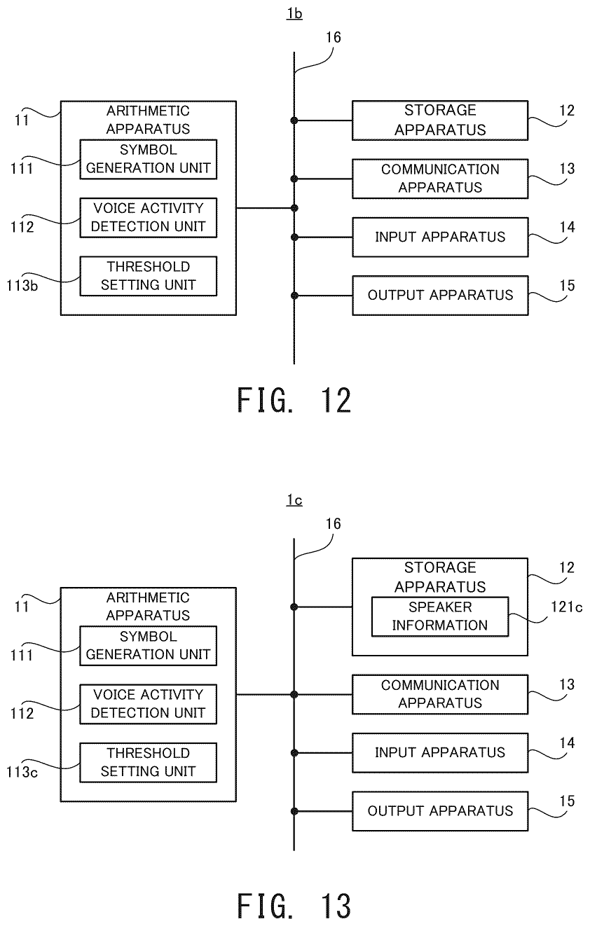

Next, a voice detection apparatus, a voice detection method, and a recording medium according to a third example embodiment will be described. With reference to FIG. 12, the following describes the voice detection apparatus, the voice detection method, and the recording medium according to the third example embodiment, by using a voice detection apparatus 1b to which the voice detection apparatus, the voice detection method, and the recording medium according to the third example embodiment are applied. FIG. 12 is a block diagram illustrating a configuration of the voice detection apparatus 1b in the third example embodiment.

As illustrated in FIG. 12, the voice detection apparatus 1b in the third example embodiment is different from the voice detection apparatus 1 in the second example embodiment in that it includes a threshold setting unit 113b in place of the threshold setting unit 113. Other features of the voice detection apparatus 1b may be the same as those of the voice detection apparatus 1.

The threshold setting unit 113b is different from the threshold setting unit 113 in that a different property from the length Lt is used as the property of the provisional voice segment used to set the threshold TH. Other features of the threshold setting unit 113b may be the same as those of the threshold setting unit 113.

For example, the threshold setting unit 113b may use the number of characters included in the provisional voice segment (e.g., the number of characters represented by the character symbol), as the property of the provisional voice segment. Here, as the length Lt of the provisional voice segment becomes longer, there may be a larger number of characters included in the provisional voice segment. Therefore, the number of characters included in the provisional voice segment has a correlation with the length Lt of the provisional voice segment. Therefore, an operation of setting the threshold TH on the basis of the number of characters included in the provisional voice segment, may be regarded as substantially equivalent to the operation of setting the threshold TH on the basis of the length Lt of the provisional voice segment. In this case, the threshold setting unit 113b may set the threshold TH on the basis of the number of characters included in the provisional voice segment, in the same manner as in the case of setting the threshold TH on the basis of the length Lt of the provisional voice segment. For example, the threshold setting unit 113b may set the threshold TH such that the threshold TH set when the number of characters included in the provisional voice segment is a first number, is greater than the threshold TH set when the number of characters included in the provisional voice segment is a second number that is greater than the first number.

For example, the threshold setting unit 113b may use the number of words included in the provisional voice segment, as the property of the provisional voice segment. Since the word is a combination of characters, the voice detection apparatus 1 is capable of detecting the word on the basis of the character symbol included in the symbol data. Specifically, the threshold setting unit 113b is capable of detecting the word by performing morphological analysis on the character symbols included in the symbol data. Therefore, the threshold setting unit 113b is capable of calculating the number of words included in the provisional voice segment. Here, as the length Lt of the provisional voice segment becomes longer, there may a larger number of words included in the provisional voice segment. Therefore, the number of words included in the provisional voice segment has a correlation with the length Lt of the provisional voice segment. Therefore, an operation of setting the threshold TH on the basis of the number of words included in the provisional voice segment, may be regarded as substantially equivalent to the operation of setting the threshold TH on the basis of the length Lt of the provisional voice segment. In this case, the threshold setting unit 113b may set the threshold TH on the basis of the number of words included in the provisional voice segment, in the same manner as in the case of setting the threshold TH based on the length Lt of the provisional voice segment. For example, the threshold setting unit 113b may set the threshold TH such that the threshold TH set when the number of words included in the provisional voice segment is a first number, is greater than the threshold TH set when the number of words included in the provisional voice segment is a second number that is greater than the first number.

For example, the threshold setting unit 113b may use a speaking speed of the voice that appears in the provisional voice segment, as the property of the provisional voice segment. As the speaking speed is higher, there may be a larger number of character symbols included in a certain voice segment. As a result, as the number of character symbols included in the voice segment increases, a larger calculation amount is required for the post-processing operation. Therefore, in view of the calculation amount required for the post-processing operation, it is preferable that as the speaking speed is higher, the length of the voice segment is shorter (resulting in a smaller number of character symbols included in the voice segment). Therefore, the threshold setting unit 113b may set the threshold TH such that the threshold TH is smaller/shorter in length as the speaking speed is higher. For example, the threshold setting unit 113b may set the threshold TH such that the threshold TH set when the speaking speed in the provisional voice segment is a first speed, is smaller than the threshold TH set when the speaking speed in the provisional voice segment is a second speed that is less than the first speed.

As the speaking speed is higher, there are a larger number of characters (i.e., a larger number of character symbols) per unit hour. Furthermore, as the speaking speed is higher, there are a larger number of words per unit time. In addition, as the speaking speed is higher, there are a smaller number of blank symbols per unit time. Therefore, the threshold setting unit 113b may calculate at least one of the number of characters (i.e., the number of character symbols) per unit time, and the number of words per unit time, and the number of blank symbols per unit time, as an index value representing the speaking speed.

For example, the threshold setting unit 113b may use the number of character symbols included in the provisional voice segment, as the property of the provisional voice segment. Here, as the length Lt of the provisional voice segment becomes longer, there may be a larger number of character symbols included in the provisional voice segment. Therefore, the number of character symbols included in the provisional voice segment has a correlation with the length Lt of the provisional voice segment. Therefore, an operation of setting the threshold TH on the basis of the number of character symbols included in the provisional voice segment, may be regarded as substantially equivalent to the operation of setting the threshold TH on the basis of the length Lt of the provisional voice segment. In this case, the threshold setting unit 113b may set the threshold TH on the basis of the number of character symbols included in the provisional voice segment, in the same manner as in the case of setting the threshold TH on the basis of the length Lt of the provisional voice segment. For example, the threshold setting unit 113b may set the threshold TH such that the threshold TH set when the number of character symbols included in the provisional voice segment is a first number, is greater than the threshold TH set when the number of character symbols included in the provisional voice segment is a second number that is greater than the first number.

The voice detection apparatus 1b in the third example embodiment can enjoy the same effects as the effects that can be enjoyed by the voice detection apparatus 1 in the second example embodiment.

### (4) Fourth Example Embodiment

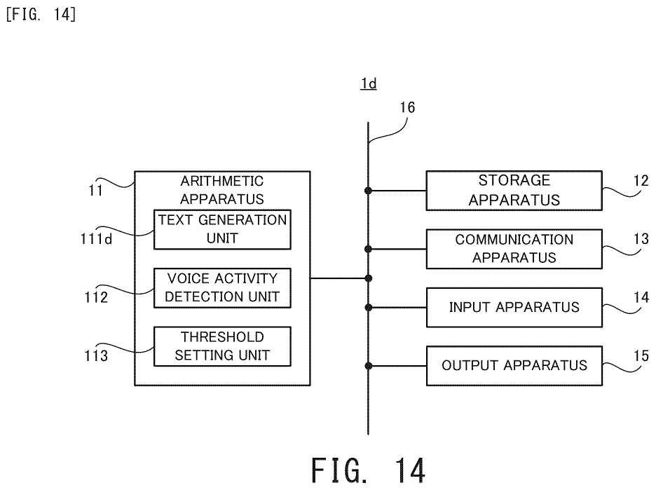

Next, a voice detection apparatus, a voice detection method, and a recording medium according to a fourth example embodiment will be described. With reference to FIG. 13, the following describes the voice detection apparatus, the voice detection method, and the recording medium according to the fourth example embodiment, by using a voice detection apparatus 1c to which the voice detection apparatus, the voice detection method, and the recording medium according to the fourth example embodiment are applied. FIG. 13 is a block diagram illustrating a configuration of the voice detection apparatus 1c in the fourth example embodiment.

As illustrated in FIG. 13, the voice detection apparatus 1c in the fourth example embodiment is different from at least one of the voice detection apparatus 1 in the second example embodiment to the voice detection apparatus 1b in the third example embodiment, in that it includes a threshold setting unit 113c in place of the threshold setting unit 113. Furthermore, the voice detection apparatus 1c in the fourth example embodiment is different from at least one of the voice detection apparatus 1 in the second example embodiment to the voice detection apparatus 1b in the third example embodiment, in that the storage apparatus 12 stores speaker information 121c. Other features of the voice detection apparatus 1c may be the same as those of at least one of the voice detection apparatuses 1 and 1b.

The threshold setting unit 113c is different from at least one of the threshold setting units 113 and 113b described above, in that the threshold TH is set on the basis of the speaker information 121c, in addition to or in place of the property of the provisional voice segment. Other features of the threshold setting unit 113c may be the same as those of at least one of the threshold setting units 113 and 113b.

The speaker information 121c includes information about characteristics of the voice uttered by the speaker. For example, the storage apparatus 12 may include first speaker information including information about characteristics of a voice uttered by a first speaker, and second speaker information including information about characteristics of a voice uttered by a second speaker.

The speaker information 121c may include information about a result of the voice detection operation that is performed on the basis of the voice signal indicating a voice uttered by a certain speaker, as the information about the characteristics of the voice uttered by the utterer. For example, the speaker information 121c may include at least one of information about an average of the length of the voice segment detected (or other arithmetic values, and hereinafter the same shall apply), information about an average of the length of the non-voice segment detected, information about an average of the number of characters uttered per unit time, information about an average of the number of words uttered per unit time, and information about the speaking speed.

The threshold setting unit 113c may identify the speaker from whom the voice signal inputted to the voice detection apparatus 1c is acquired, may acquire the speaker information 121c corresponding to the identified speaker from the storage apparatus 12, and may set the threshold TH on the basis of the acquired speaker information 121c. For example, as the average of the length of the voice segment indicated by the uttered speaker information 121c becomes longer, the threshold setting unit 113c may set the threshold TH to be a larger value such that a relatively long voice segment is detected. For example, the threshold setting unit 113c may set the threshold TH to the average of the length of the non-voice segment indicated by the speaker information 121c, or to a value close to the average. For example, the threshold TH may be set to a lower value such that as the average of the number of characters indicated by the speaker information 121c increases, a relatively short voice segment (resulting in a voice segment in which the number of included characters is not excessively large) is detected. For example, the threshold TH may be set to a lower value such that as the average of the number of words indicated by the speaker information 121c increases, a relatively short voice segment (resulting in a voice segment in which the number of included words is not excessively large) is detected. For example, the threshold TH may be set to a lower value such that as the speaking speed indicated by the speaker information 121c is higher, a relatively short voice segment (resulting in a voice segment in which the number of included characters is not excessively large) is detected.

The voice detection apparatus 1c in the fourth example embodiment can enjoy the same effect as the effect that can be enjoyed by at least one of the voice detection apparatus 1 in the second example embodiment to the voice detection apparatus 1b in the third example embodiment. In addition, the voice detection apparatus 1c is capable of setting the threshold TH that matches the characteristics of the voice uttered by the speaker. Therefore, the voice detection apparatus 1c is capable of more properly detecting the voice segment in view of a difference in the characteristics of the voice uttered by the speaker.

### (5) Fifth Example Embodiment

Next, a voice detection apparatus, a voice detection method, and a recording medium according to a fifth example embodiment will be described. With reference to FIG. 14, the following describes the voice detection apparatus, the voice detection method, and the recording medium according to the fifth example embodiment, by using a voice detection apparatus 1d to which the voice detection apparatus, the voice detection method, and the recording medium according to the fifth example embodiment are applied. FIG. 14 is a block diagram illustrating a configuration of the voice detection apparatus 1d in the fifth example embodiment.

As illustrated in FIG. 14, the voice detection apparatus 1d in the fifth example embodiment is different from at least one of the voice detection apparatus 1 in the second example embodiment to the voice detection apparatus 1c in the fourth example embodiment, in that it includes a text generation unit 111d in place of the symbol generation unit 111. Other features of the voice detection apparatus 1d may be the same as those of at least one of the voice detection apparatuses 1, 1b and 1c.

The text generation unit 111d is different from the symbol generation unit 111 that generates the symbol data by using the CTC model, in that it generates, from the voice signal, text data representing the voice uttered by the speaker as characters, without using the CTC model. For example, the text generation unit 111d calculates the posterior probability of the character string by using an acoustic model, a pronunciation dictionary, and a language model, and generates, as the text data, serial data on a plurality of texts that constitute the character string having the highest posterior probability. Even in this case, the voice activity detection unit 112 may determine the beginning of the voice segment from the generated text data, and may then determine the end of the voice segment by comparing the length Lb of the non-voice segment with the threshold TH. Furthermore, the threshold setting unit 113 may set the threshold TH on the basis of the length Lt of the provisional voice segment. As a consequence, it is possible to enjoy the above-described benefit even when the CTC model is not used.

In a case where the text generation unit 111d generates the text data by using the pronunciation dictionary (i.e., dictionary data), the threshold setting unit 113 may set the threshold TH on the basis of a property of the pronunciation dictionary. For example, in a case where the pronunciation dictionary has a property of generating the text data including many kanji characters, the threshold setting unit 113 may set the threshold TH to a smaller value than a standard value such that a relatively short voice segment (resulting in a voice segment in which the number of included characters is not excessively large) is detected.

The voice detection apparatus 1d in the fifth example embodiment described above can enjoy the same effect as the effect that can be enjoyed by at least one of the voice detection apparatus 1 in the second example embodiment to the voice detection apparatus 1c in the fourth example embodiment. In addition, the voice detection apparatus 1d is capable of setting the threshold TH on the basis of the pronunciation dictionary: Therefore, the voice detection apparatus 1d is capable of more properly detecting the voice segment in view of a difference in an operation of converting the voice signal into the text data.

### (6) Supplementary Notes

With respect to the example embodiment described above, the following Supplementary Notes are further disclosed.

### [Supplementary Note 1]

A voice detection apparatus including:
a beginning determination unit that determines a beginning of a voice segment including a voice that appears in a voice signal;
an end determination unit that determines an end of the voice segment by determining whether or not a length of a non-voice segment that appears after the beginning is determined, is greater than or equal to a threshold; and
a setting unit that sets the threshold on the basis of a property of a provisional voice segment starting from the beginning.

### [Supplementary Note 2]

The voice detection apparatus according to Supplementary Note 1, wherein the property of the provisional voice segment includes a length of the provisional voice segment.

### [Supplementary Note 3]

The voice detection apparatus according to Supplementary Note 2, wherein the setting unit sets the threshold such that the threshold set when the length of the provisional voice segment is a first length, is greater than the threshold set when the length of the provisional voice segment is a second length that is longer than the first length.

### [Supplementary Note 4]

The voice detection apparatus according to any one of Supplementary Notes 1 to 3, wherein the property of the provisional voice segment includes at least one of a number of characters of the voice included in the provisional voice segment, a number of words of the voice included in the provisional voice segment, and a speaking speed of the voice included in the provisional voice segment.

### [Supplementary Note 5]

The voice detection apparatus according to any one of Supplementary Notes 1 to 4, wherein
the voice detection apparatus further includes a generation unit that generates, from the voice signal, symbol data including a character symbol and a blank symbol, by using a CTC (Connectionist Temporal Classification) model,
the beginning determination unit determines the beginning on the basis of the symbol data,
the end determination unit determines the end on the basis of the symbolic data, and
the non-voice segment includes a segment in which the blank symbol appears continuously.

### [Supplementary Note 6]

The voice detection apparatus according to Supplementary Note 5, wherein the property of the provisional voice segment includes a number of character symbols included in the provisional voice segment.

### [Supplementary Note 7]

The voice detection apparatus according to any one of Supplementary Notes 1 to 6, wherein
the voice detection apparatus further includes a storage unit that stores, for each speaker, speaker information about characteristics of a voice uttered by the speaker, and
the setting unit identifies a speaker from whom the voice signal is acquired, and sets the threshold on the basis of the speaker information corresponding to the identified speaker.

### [Supplementary Note 8]

The voice detection apparatus according to any one of Supplementary Notes 1 to 7, wherein
the voice detection apparatus further includes a conversion unit that converts the voice signal into text data by analyzing the voice signal by using dictionary data, and
the setting unit sets the threshold on the basis of a property of the dictionary data.

### [Supplementary Note 9]

A voice detection method including:
determining a beginning of a voice segment including a voice that appears in a voice signal;
determining an end of the voice segment by determining whether or not a length of a non-voice segment that appears after the beginning is determined, is greater than or equal to a threshold; and
setting the threshold on the basis of a property of a provisional voice segment starting from the beginning.

### [Supplementary Note 10]

A recording medium on which a computer program that allows a computer to execute a voice detection method is recorded, the voice detection method including:
determining a beginning of a voice segment including a voice that appears in a voice signal;
determining an end of the voice segment by determining whether or not a length of a non-voice segment that appears after the beginning is determined, is greater than or equal to a threshold; and
setting the threshold on the basis of a property of a provisional voice segment starting from the beginning.

At least a part of the constituent components of each of the example embodiments described above can be combined with at least another part of the constituent components of each of the example embodiments described above, as appropriate. A part of the constituent components of each of the example embodiments described above may not be used. Furthermore, to the extent permitted by law, all the references (e.g., publications) cited in this disclosure are incorporated by reference as a part of the description of this disclosure.

This disclosure is allowed to be changed, if desired, without departing from the essence or spirit of this disclosure which can be read from the claims and the entire identification. A voice detection apparatus, a voice detection method, and a recording medium with such changes are also intended to be within the technical scope of this disclosure.

### DESCRIPTION OF REFERENCE CODES

1 Voice detection apparatus
11 Arithmetic apparatus
111 Symbol generation unit
112 Voice activity detection unit
113 Threshold setting unit
1000 Voice detection apparatus
1001 Beginning determination unit
1002 End determination unit
1003 Setting unit

What is claimed is:

1. A voice detection apparatus comprising:
at least one memory configured to store instructions; and
at least one processor configured to execute the instructions to:
determines a beginning of a voice segment including a voice that appears in a voice signal;
determines an end of the voice segment by determining whether or not a length of a non-voice segment that appears after the beginning is determined, is greater than or equal to a threshold; and
set the threshold on the basis of a property of a provisional voice segment starting from the beginning.

2. The voice detection apparatus according to claim 1, wherein the property of the provisional voice segment includes a length of the provisional voice segment.

3. The voice detection apparatus according to claim 2, wherein the at least one processor is configured to execute the instructions to set the threshold such that the threshold set when the length of the provisional voice segment is a first length, is greater than the threshold set when the length of the provisional voice segment is a second length that is longer than the first length.

4. The voice detection apparatus according to claim 1, wherein the property of the provisional voice segment includes at least one of a number of characters of the voice included in the provisional voice segment, a number of words of the voice included in the provisional voice segment, and a speaking speed of the voice included in the provisional voice segment.

5. The voice detection apparatus according to claim 1, wherein
the at least one processor is configured to execute the instructions to:
generate, from the voice signal, symbol data including a character symbol and a blank symbol, by using a CTC (Connectionist Temporal Classification) model,
determine the beginning on the basis of the symbol data, and
determine the end on the basis of the symbolic data, and
the non-voice segment includes a segment in which the blank symbol appears continuously.

6. The voice detection apparatus according to claim 5, wherein the property of the provisional voice segment includes a number of character symbols included in the provisional voice segment.

7. The voice detection apparatus according to claim 1, wherein
the voice detection apparatus further comprises a storage unit that stores, for each speaker, speaker information about characteristics of a voice uttered by the speaker, and
the at least one processor is configured to execute the instructions to identify a speaker from whom the voice signal is acquired, and sets the threshold on the basis of the speaker information corresponding to the identified speaker.

8. The voice detection apparatus according to claim 1, wherein
the at least one processor is configured to execute the instructions to:
convert the voice signal into text data by analyzing the voice signal by using dictionary data, and
set the threshold on the basis of a property of the dictionary data.

9. A voice detection method comprising:
determining a beginning of a voice segment including a voice that appears in a voice signal;
determining an end of the voice segment by determining whether or not a length of a non-voice segment that appears after the beginning is determined, is greater than or equal to a threshold; and
setting the threshold on the basis of a property of a provisional voice segment starting from the beginning.

10. A non-transitory recording medium on which a computer program that allows a computer to execute a voice detection method is recorded, the voice detection method including:
determining a beginning of a voice segment including a voice that appears in a voice signal;
determining an end of the voice segment by determining whether or not a length of a non-voice segment that appears after the beginning is determined, is greater than or equal to a threshold; and
setting the threshold on the basis of a property of a provisional voice segment starting from the beginning.
